(19) United States
(12) Patent Application Publication
(10) Pub. No.: US 2022/0167588 A1
(43) Pub. Date: Jun. 2, 2022

(54) PET TOY CONCEALED IN CAN

(71) Applicant: Danielle Salyer, Denver, CO (US)

(72) Inventor: Danielle Salyer, Denver, CO (US)

(21) Appl. No.: 17/106,139

(22) Filed: Nov. 29, 2020

(51) Int. Cl. A01K 15/02; G10K 5/00; B65D 85/00

(52) U.S. Cl. CPC A01K 15/025; B65D 85/70; G10K 5/00

(57) ABSTRACT

The invention is a series of three plush squeaking toys that are obscured within a decorative pop top can so that the user cannot see which character is inside the can, and provides a surprise toy which encourages the consumer to collect the set.

### FIELD

The present invention relates generally to stimulating, encouraging and motivating games and methods of playing regarding pets, e.g. dogs and cats. More particularly, the invention relates to motivational games, toys and methods for assessing the pet training skills in the form of games or puzzles that incite pet interaction and memory skills.

### PRIOR ART

There are many types of pet toys on the market that squeak, roll, light up, among others. This novel toy offers fun for the pet owner as the characters are concealed within a decorated opaque pop top can.

### BRIEF DESCRIPTION OF THE INVENTION

The novel design of the inventive toy encompasses a plush squeaking toy that is concealed and packaged inside a decorated opaque pop top can wherein the consumer does not know which of 3 “characters” are enclosed therein. The present embodiment of the characters includes a carrot, a mushroom, and a broccoli crown.

One of three characters are sealed within the pop top can so that the buyer is surprised by the character therein. The intent is to encourage the consumer to “collect” all three characters.

Each plush toy contains noisemaking capabilities, and each have facial features to further provide character to the plush toys.

### BACKGROUND OF THE INVENTION

The invention most closely corresponds with USPTO Class 119/707 wherein Class 119 relates to animal husbandry and sub-class 707 includes toys.

In its simplest form, the invention relates to a novel toy for pets and owners wherein a series of three plus characters are secreted within a decorated pop top can that conceals which of the characters is inside.

### THE INVENTION

### Summary, Objects and Advantages

It well known that pets do experience a sense of boredom, and if not addressed, may manifest in negative behavior such as chewing furniture or going to the bathroom in undesirable locations in the pet owner's home. The inventive toy is designed to capture and retain a pet's interest as well as provide a surprise for the pet owner when the character is revealed from within the decorated pop top can.

### BRIEF DESCRIPTION OF THE DRAWINGS

The invention is described in further detail by reference to eight (8) drawings sufficient in detail to describe the invention in which:

FIG. 1 is a front illustration of the broccoli crown character;

FIG. 2 is a rear perspective of the broccoli crown character;

FIG. 3 is a front perspective of the carrot character;

FIG. 4 is a rear perspective of the carrot character;

FIG. 5 is a front perspective of the mushroom character;

FIG. 6 is a rear perspective of the mushroom character;

FIG. 7 illustrates the front of the pop top can; and

FIG. 8 is the rear side of the pop top can.

### DETAILED DESCRIPTION, INCLUDING BEST MODES OF CARRYING OUT THE INVENTION

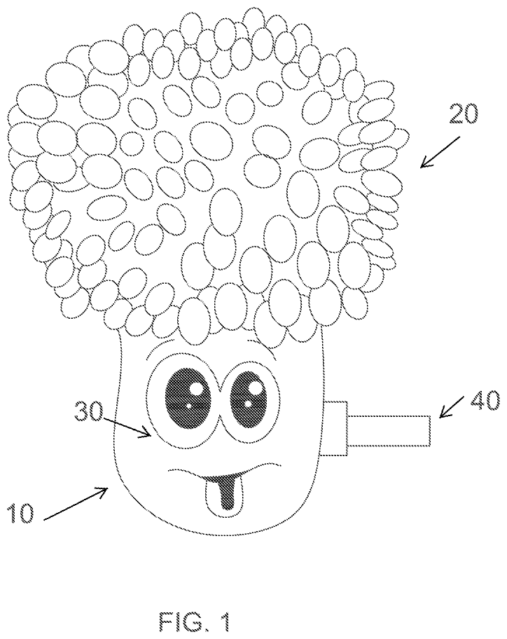

FIG. 1 shows the broccoli crown plush character 10. The crown portion 20 is made to resemble the associated vegetable. The plush toy is sewn together using turn seamed construction. The broccoli character has embroidered facial features 30 giving the toy a facial expression. A tag 40 is affixed to each plush toy to provide required material and origin content, as well as cleaning instructions. A squeaker and optionally a section of polyfill are sewn inside the plush toy character to emit sound when depressed.

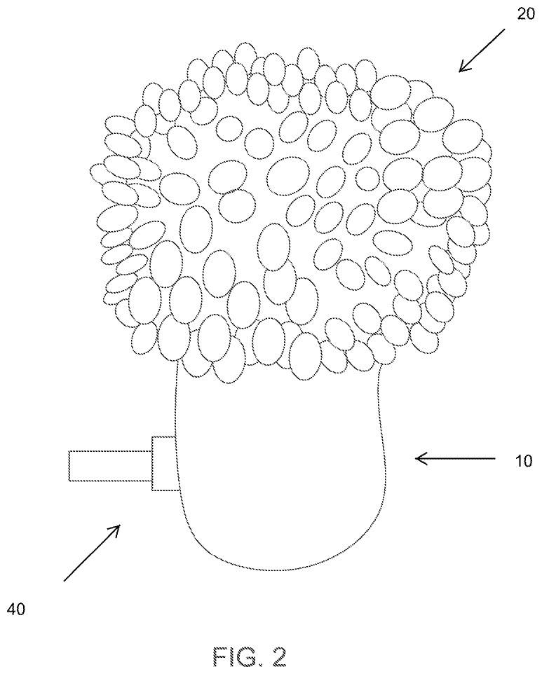

FIG. 2 is the rear side of the broccoli character, again showing the body 10 and crown of broccoli on the head portion 20. The externally located product tag 40 is an integral feature due to law governing product fabric and origin data.

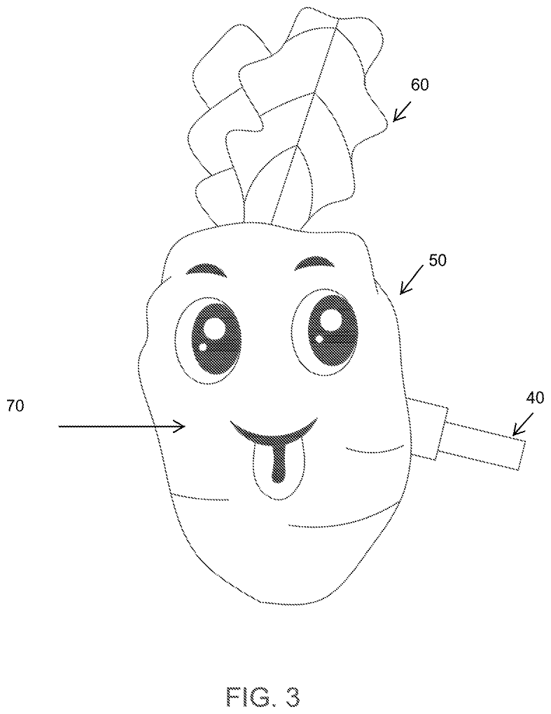

FIG. 3 is an embodiment of the carrot character. The plush character body 50 is made to resemble an actual carrot, along with the leafy portion atop the carrot's head 60. Facial features are embroidered on the face of the carrot to provide expression unique to the carrot character 70. The tag 40 containing fabric and origin data is again sewn into the plush body. The carrot is also made with turned seam construction and a squeaker and optionally a section of polyfill are sewn inside the plush toy character to emit sound when depressed.

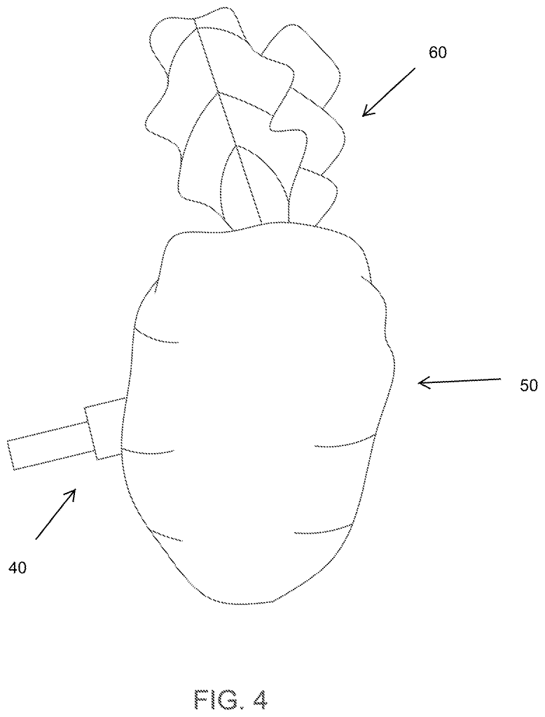

FIG. 4 is the rear side of the carrot character, again showing the body 50 and a leafy portion on the head 60 of the carrot. The externally located product tag 40 is an integral feature due to law governing product fabric and origin data.

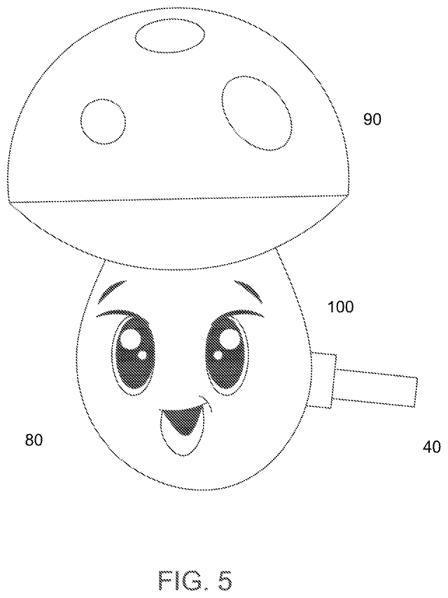

FIG. 5 is an embodiment of the mushroom character. The body 80 is turn seam construction plush material with facial features 100 unique to the mushroom character which are embroidered on the face of the mushroom. The mushroom character has a spotted top 90 as one might see in an actual mushroom found outdoors. And again the tag 40 showing fabric content and origin data is sewn into the plush body to be visible to the consumer.

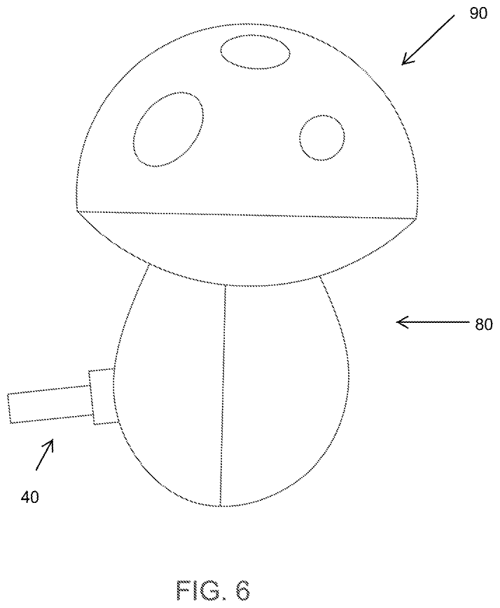

FIG. 6 is the rear of the mushroom character showing the body 80 and the spotted top 90 as well as the tag 40 containing fabric and origin data.

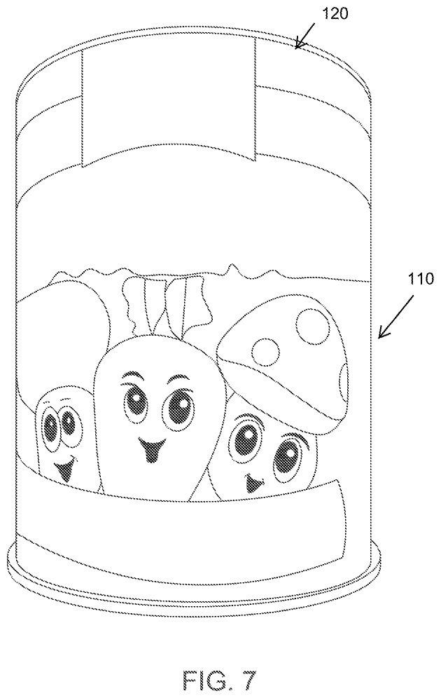

FIG. 7 is the front side of the can which shows each of the three characters in cartoon illustration 110. Which character is inside the can is not revealed as the can designs are opaque so as to obscure which character is within. A standard pop top 120 is not shown but can be inferred to be a standard ring pop top wherein a user simply pulls the ring and the top separates from the can.

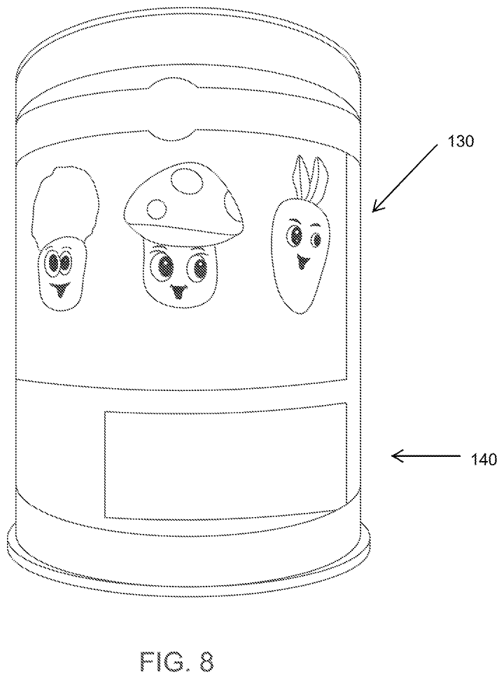

FIG. 8 shows the rear side of the pop top can with a different cartoon illustration of the three characters 130. A section of the can has a space for label data as may be the option of a particular reseller of the toy 140.

1) A pet toy comprising:
a) A plush animal with squeaker concealed inside a pull-top can;
b) A decorative can wherein the design is opaque so as to conceal the toy inside;
c) Three plush characters possible inside can; and
d) A pull top can with decorations wherein a user must purchase to pull top.

2) A pet toy as in claim 1 wherein one of three characters comprising a carrot, broccoli, or a mushroom are concealed in a pull-top ring style can.

3) A pet toy as in claim 1 wherein each plush character has a squeaker and may have polyfill fabric within.

4) A pet toy as in claim 1 wherein each plush character has an embroidered face and a form of top which may be felt, or fabric and which tops are turn seam sewn into the plush body.

5) A pet toy as in claim 1 wherein the decorated can has a ring pull-top cover wherein upon a user opening, one of the three possible characters will be revealed.
